(19) United States
(12) Patent Application Publication
(10) Pub. No.: US 2024/0405213 A1
(43) Pub. Date: Dec. 5, 2024

(54) METHOD FOR PREPARING ELECTROLYTIC MANGANESE DIOXIDE

(71) Applicant: EMD ACQUISITION LLC, Henderson, NV (US)

(72) Inventors: Laurie L. Jegaden, Henderson, NV (US); Phillip M. Story, Yukon, OK (US)

(21) Appl. No.: 18/690,786

(22) PCT Filed: Sep. 9, 2022
(86) PCT No.: PCT/US2022/043048

§ 371 Date: Mar. 11, 2024

Related U.S. Application Data
(60) Provisional application No. 63/244,597, filed on Sep. 15, 2021.

(51) Int. Cl. H01M 4/505; H01M 4/02; H01M 4/525

(52) U.S. Cl. CPC H01M 4/505; H01M 4/525; H01M 2004/028

(57) ABSTRACT

Disclosed herein is an improved cathode material having the general formula of Li1+xMn2−x−y−zMyM′zO4 where x is generally less than 0.25, y is less than about 0.5, z is between about 0.1 and about 0.7, M is a trivalent transition metal, M′ is a divalent transition metal. Also disclosed is an improved secondary battery having a cathode material of the general formula of Li1+xMn2−x−y−zMyM′zO4. In one embodiment, the method provides for the preparation of a solution of Mn++ ions by dissolving manganese metal, typically in the form of powder or chips, in a mineral acid. The final concentration of Mn++ in solution will be between about 20 g/L to about 254 g/L. Typically, the solution will contain about 47 g/L of Mn++. The final pH of the solution containing Mn++ may range between about two and about eight; however, a typical operational pH will be between about 5.5 and about 7.0.

### SUMMARY

Disclosed herein is improved lithium manganese oxides (LMO) having a general formula of Li₁₊ₓMn_{2-x-y-z}M_{y}M′_{z}O₄ where x is less than or equal to 0.25, and the value for y is less than or equal to 0.5, z is between about 0.1 and about 0.7, M is one or more trivalent transition metals and M′ is a divalent transition metal, such as, but not limited to Ni. The lithium manganese oxides have less than 175 ppm of trace metals. Specifically, the LMO has less than 30 ppm Al, less than 130 ppm Ca, less than 90 ppm K, less than 75 ppm Mg, less than 35 ppm Fe and less than 50 ppm Na. As used herein, the term LMO refers to a cathode material suitable for use in a secondary battery.

In another embodiment, the present disclosure relates to a secondary battery. The secondary battery comprises a cathode material using the Li₁₊ₓMn_{2-x-y-z}M_{y}M′_{z}O₄. The secondary battery has a maximum capacity of at least 115 mAhr/g of cathode active material and the secondary battery is capable of at least 370 charge/discharge cycles after the secondary battery has reached maximum capacity before the rechargeable capacity of said battery drops below 80% of the maximum capacity.

### DETAILED DESCRIPTION

The present disclosure may be understood more readily by reference to the following description. The following description is not to be considered as limiting the scope of the embodiments described herein. Also, the phraseology and terminology employed herein is for the purpose of description and should not be regarded as limiting except where indicated as such. Further, throughout this disclosure, the terms “about”, “approximate”, and variations thereof, are used to indicate that a value includes the inherent variation or error for the device, system, or measuring method being employed as recognized by those skilled in the art.

The disclosed cathode material can be prepared according to the following methods which provide for the conversion of metal manganese to MnO₂. Subsequently, the method provides for conversion of MnO₂ (EMD) to Mn₂O₃.

In one embodiment, the method provides for the preparation of a solution of Mn⁺⁺ ions by dissolving manganese metal, typically in the form of powder or chips, in a mineral acid. Typically, the method will utilize sulfuric acid; however, nitric acid and other mineral acids capable of dissolving at least 47 g/l of Mn⁺⁺ will perform satisfactorily. The final concentration of Mn⁺⁺ in solution will be between about 20 g/L to about 254 g/L. Typically, the solution will contain about 47 g/L of Mn⁺⁺. The final pH of the solution containing Mn⁺⁺ may range between about two and about eight; however, a typical operational pH will be between about 5.5 and about 7.0.

Mineral acid solution containing Mn⁺⁺ flows to a series of electrolytic cells. An electric current passes through the electrolytic cells at a current density between about 2.5 Amp/ft² and 6 Amp/ft². During the application of current, MnO₂ plates out on the anodes of the electrolytic cells. The plating process generally operates at temperatures of about 93° C. to about 99° C. as the acid solution flows through the cells. Acid solution exiting the cells has been substantially depleted of Mn⁺⁺ ions. The depleted acid is used to dissolve additional manganese metal and is returned to the cells. Typically, the plating process continues for about three to about 40 days when operating at the indicated current densities.

After the electrolytic cells have been taken offline, i.e. upon completion of the plating process, MnO₂ is collected from the anodes, ground or crushed to a size suitable for neutralization, neutralized by treatment with a base, filtered, dried and undergoes an additional particle reduction step.

The grinding or crushing of the collected MnO₂ may be carried out using any conventional method including but not limited to a plate crusher or plate grinder. The grinding process increases particle surface area thereby improving the subsequent neutralization step. The resulting MnO₂ will generally have a particle size of 2 mm or less.

Base solutions used for the neutralization step will have a pH between about 8 and about 12 and must not introduce contaminants to the solid MnO₂. Typically, the neutralization step will use lithium hydroxide, lithium carbonate, lithium bicarbonate, ammonium hydroxide or mixtures thereof. Bases such as sodium hydroxide, calcium hydroxide and potassium hydroxide are not preferred, as they will likely contaminate the resulting MnO₂ with undesirable calcium, sodium and potassium. Ammonium hydroxide will be particularly advantageous during the neutralization step as it may be removed during heating of the resulting MnO₂ particles. The neutralization step yields an EMD having very high purity, i.e. trace elements such as Ca, Al, K, Mg and Na are extremely low in concentration or not found in the resulting EMD. Specifically, the cathode material has less than 10 ppm Al, less than 50 ppm Ca, less than 50 ppm K, less than 15 ppm Mg and less than 50 ppm Na

The neutralization step may take place at temperatures ranging from room temperature to about the boiling point of the slurry or solution for a period of about 20 minutes to about 120 minutes. In general, the neutralization step is considered complete when the effluent from the particles or the slurry of particles has a pH above 5.5. In this method, neutralization is a diffusion-limited process. As a result, the neutralization solution must contain excess base to drive the diffusion. To enhance distribution of the base solution and promote washing of anions from the surfaces of the product, the preferred pH of the neutralization solution will be in the range of about 8 to about 10. Excess liquid produced during the neutralization step is discarded along with the resulting salts.

Following neutralization, drying and collection, the resulting MnO₂ particles undergo size reduction and classification. Typically, the size reduction step will utilize a jet mill; however, other devices will also provide satisfactory particles. The desired resulting particles generally have particle sizes ranging from about 100 nm up to about 300 micrometers. A typical batch of MnO₂ particles may have a median particle size of about 10 micrometers. However, batches of MnO₂ suitable for conversion to Mn₂O₃ may have a median particle size as low as 3 micrometers and other batches may have a median particle size as large as 35 micrometers.

The final EMD produced by the above-described method is of very high purity. For example, EMD produced at a current density of 5.6 Amp/ft², at a temperature of 96° C. using a sulfuric acid solution containing 47.3 g of Mn⁺⁺ per liter was compared to conventional EMD. The impurity values of the high purity EMD versus the conventional EMD are provided in Table 1 below. Note: the impurity levels in the subsequent cathode material will differ from the impurity levels of the EMD as the addition of the lithium component will reduce the final impurity levels in the cathode material.

TABLE 1

| Impurity | Conventional EMD | High Purity EMD |
|---|---|---|
| Aluminum (Al) | >100 | <10 |
| Calcium (Ca) | >150 | <50 |
| Potassium (K) | >200 | <50 |
| Magnesium (Mg) | >50 | <15 |
| Sodium (Na) | >75 | <50 |

Following isolation of the desired MnO₂ particles, the method converts the MnO₂ particles, i.e. high purity EMD, to Mn₂O₃ by heating at a temperature between about 700° C. and about 850° C. for a period between about 1 and about 24 hours under an atmosphere of air. Generally, the heating occurs between about 725° C. and about 775° C. for a period between about 2 and about 12 hours. Preferably, heating takes place at about 700° C. for about 12 hours. The resulting Mn₂O₃ particles have surface areas between about 0.5 m²/gram and about 5 m²/gram.

As demonstrated by the following examples, the resulting Mn₂O₃ particles are suitable for use in manufacturing a lithium manganese oxide (LiMn₂O₄) cathode material. The Mn₂O₃ particles are combined with Li₂CO₃, LiOH, Li₂O, HLiCO₃ and additional metal oxides as a doping material. The preferred metal oxides included, but are not limited to, NiCO₃, NiO, nickel acetate, nickel nitrate, nickel hydroxide and other forms of nickel suitable for inclusion in cathode material.

The final formulation of the cathode material will generally be Li₁₊ₓMn_{2-x-y-z}M_{y}M′_{z}O₄ where x is less than or equal to 0.25, and y is less than or equal to about 0.5, z is between about 0.1 and about 0.7, M is one or more trivalent transition metals, and M′ is a divalent transition metal, such as but not limited to Ni. More typically, in the final formulation z will be between 0.2 and 0.7. Thus, the final formulation may contain up to about 15 percent by weight of one or more trivalent transition metals and may contain between about 3 and about 24 percent by weight of a divalent transition metal. The preferred divalent transition metal is currently nickel. Typically, the divalent transition metal will be present in the range of about 6 to about 22.4 percent by weight of the cathode material.

Additionally, the cathode material used has less than 175 ppm of trace metals. Specifically, the cathode material has less than 30 ppm Al, less than 130 ppm Ca, less than 90 ppm K, less than 75 ppm Mg, and less than 35 ppm Fe. More typically, the cathode material has than 20 ppm Al, less than 110 ppm Ca, less than 80 ppm K, less than 65 ppm Mg, and less than 25 ppm Fe. Note: in another embodiment, the improved cathode material is free of trivalent metals. In this embodiment the general formula of the improved cathode material would be Li₁₊ₓMn_{2-x-z}M′_{z}O₄, where x is less than or equal to 0.25 and z is between about 0.1 and about 0.7. More typically, in the final formulation z will be between 0.2 and 0.7.

In this example, 1648.6 grams of Mn₂O₃ particles (median particle size of 10 micrometers) prepared according to the method outlined above, were blended with 826.4 grams of NiCO₃ to provide a homogeneous mixture. The resulting mixture was heated to 925° C. in air for 24 hours and subsequently cooled to room temperature. Following cooling the product was broken up and blended with 514.5 grams of Li₂CO₃ to provide a homogeneous mixture. The resulting mixture was heated to 750° C. for 10 hours and subsequently cooled at 1° C./minute to room temperature. The final product, having the formula of LiMn_{1.5}Ni_{0.5}O₄, was then ground and screened to remove any particles larger than 45 micrometers. When the final formulation of the cathode material represented by Li₁₊ₓMn_{2-x-y-z}M_{y}M′_{z}O₄ has values of zero for x and y, then one suitable formulation may be LiMn_{1.5}Ni_{0.5}O₄, x=0, y=0 and z=0.5. Table 2 provides the trace metal concentrations in the cathode material having the formulation of LiMn_{1.5}Ni_{0.5}O₄, as used in the improved secondary battery.

Cathodes prepared from the final product were tested as part of improved secondary batteries having carbon anodes, i.e. the improved secondary batteries are full cells, not a half-cells. The improved secondary batteries were repeatedly cycled at room temperature, i.e. about 25° C., at a rate of one full discharge to a level of 3.0V completed in three hours, followed by a 3 hour charge to a level of 4.9V to provide an average working discharge value of 4.7V. The improved secondary batteries had an average fade rate of 0.054%/cycle and maximum capacity of at least 115 mAhr/g. The theoretical capacity of a secondary battery made using a cathode of the formula, LiNi_{0.5}Mn_{1.5}O₄, would be 146.2 mAhr/g as determined by the available lithium in the cathode material. Thus, the final maximum capacity of the secondary battery is 78.7% of the theoretical value.

As known to those skilled in the art, a secondary battery does not necessarily achieve full capacity on the initial charge. Accordingly, the life span and fade rate of a rechargeable battery, i.e. a secondary battery, are determined based on the maximum capacity of the battery. Typically, after achieving maximum capacity, each time a secondary battery is recharged, the final charge capacity of the secondary battery is reduced. When the battery can no longer be charged to 80% of the maximum capacity, the battery is considered to be at the “end of life.” Rechargeable batteries, prepared from the described improved material will provide at least 370 charge/discharge cycles. Note: while the secondary batteries used to determine the improvement provided by the cathode formulation of Li₁₊ₓMn_{2-x-y-z}M_{y}M′_{z}O₄, used graphite as the anode, other anode materials may be substituted in place of graphite.

To provide a direct comparative example, conventional lithium neutralized alkaline battery grade electrolytic manganese dioxide (EMD) was converted to Mn₂O₃ and treated according to the steps described in the above example to prepare a cathode material having the formulation of LiMn_{1.5}Ni_{0.5}O₄. This conventional cathode material contains nickel but differs from the cathode material containing nickel described above in that key impurities (Al, Ca, Fe, K, Mg) are present at significantly higher concentrations than typically found in currently available cathode materials (see Table 2 below) than the concentration of impurities in the improved formulation of LiMn_{1.5}Ni_{0.5}O₄ used for the cathode material of the improved secondary battery. Conventional alkaline battery grade EMD is prepared from manganous sulfate and purified according to conventional methods. Secondary batteries with cathodes prepared from the conventional lithium manganese oxide material had a fade rate of 0.067%/cycle and a maximum discharge capacity of 110 mAhr/g. Batteries prepared from this material would be expected to drop below a capacity retention of 80% after experiencing about 300 charge/discharge cycles. Additionally, the batteries have a maximum discharge capacity that is only 75% of the theoretical capacity.

TABLE 2

| | Concentration in | Concentration in |
|---|---|---|
| | LiNi_{0.5}Mn_{1.5}O₄ from | LiNi_{0.5}Mn_{1.5}O₄ from high |
| Impurity | Conventional EMD | purity EMD |
| Al | 165 ppm | 17 ppm |
| Ca | 243 ppm | 104 ppm |
| Fe | 129 ppm | 21 ppm |
| K | 170 ppm | 76 ppm |
| Mg | 100 ppm | 59 ppm |

Thus, the improved secondary batteries using cathodes prepared from the lithium manganese oxide cathode containing nickel described above have an improved average fade rate when compared to cells prepared from lithium manganese oxide synthesized with conventional alkaline battery grade EMD. The improved cathode material, disclosed herein, produced an average fade rate of only 0.054% per recharge cycle while the conventional cathode material demonstrated an average fade rate of 0.067% per recharge cycle. The improved cathode material will have a useful life of at least 370 charge/discharge cycles. In contrast, the conventional cathode material drops below 80% of maximum capacity after only 300 charge/discharge cycles. Thus, a secondary battery using a cathode having the formulation of Li₁₊ₓMn_{2-x-y-z}M_{y}M′_{z}O₄ provided a 23% improvement in charge/discharge cycles and an improvement in fade rate of 23% when compared to conventional cathode material containing nickel.

Further, when incorporated into a rechargeable battery, the cathode material having the general formula of Li₁₊ₓMn_{2-x-y-z}M_{y}M′_{z}O₄ provides higher voltages than conventional cathode materials lacking nickel. Secondary batteries containing cathodes prepared with the formulation of Li₁₊ₓMn_{2-x-y-z}M_{y}M′_{z}O₄ will have working voltages in excess of 4.0. For example, a battery containing LiNi_{0.5}Mn_{1.5}O₄ will provide a working voltage of 4.7 volts. In contrast, a battery containing a cathode with the formulation of LiMnO₄ will have a working voltage of 4 volts.

A further unexpected characteristic of the improved nickel containing cathode material is the cathode stability. Specifically, the degree of degradation due to the presence of nickel in the improved cathode material is less than expected, thereby allowing for use of nickel in the cathode material which provides improvement in working voltage, fade rate and charge/recharge cycles. As known to those skilled in the art, the presence of nickel in cathode material places stress on the structure of the cathode material during the recharge cycle. This stress generally leads to rapid degradation of the cathode. The resulting degradation significantly reduces the number of charge/discharge cycles before the secondary battery drops below 80% of maximum capacity. Accordingly, one skilled in the art would expect that a cathode material of the general formulation—Li₁₊ₓMn_{2-x-y-z}M_{y}M′_{z}O₄—would perform similar to that of the comparative test with regard to fade rate and number of charge/discharge cycles. However, when utilized in a secondary battery, the disclosed formulation not only provides an increase in the maximum capacity but also increases the number of charge/discharge cycles before reaching the secondary battery's end of life as defined above. Additionally, the improved cathode material will reduce degradation of the electrolytes in the secondary battery as evidenced by the improvement in the fade rate and increased cycle life.

Other embodiments of the present invention will be apparent to one skilled in the art. As such, the foregoing description merely enables and describes the general uses and methods of the present invention. Accordingly, the following claims define the true scope of the present invention.

What is claimed is:

1. A secondary battery comprising:
a cathode material comprising lithium manganese oxide, wherein said lithium magnesium oxide is represented by Li₁₊ₓMn_{2-x-y-z}M_{y}M′_{z}O₄ where x is generally less than 0.25, y is less than about 0.5, z is between about 0.1 and about 0.7, M is a trivalent transition metal, M′ is a divalent transition metal.

2. The secondary battery of claim 1, wherein said secondary battery has a maximum capacity of at least 115 mAhr/g of Li₁₊ₓMn_{2-x-y-z}M_{y}M′_{z}O₄.

3. The secondary battery of claim 1, wherein said secondary battery is capable of at least 370 charge/discharge cycles before the capacity of said battery drops below 80% of the maximum capacity.

4. The secondary battery of claim of claim 1, wherein M′ is nickel.

5. The secondary battery of claim 1, wherein M is up to 15% by weight of said cathode material.

6. The secondary battery of claim 1, wherein M′ is between about 3% by weight and about 24% by weight of said cathode material.

7. The secondary battery of claim 1, wherein said cathode material comprises less than 30 ppm Al, less than 130 ppm Ca, less than 90 ppm K, less than 75 ppm Mg and less than 35 ppm Fe.

8. The secondary battery of claim 1, wherein said Mn₂O₃ particles within said lithium manganese oxide have surfaces areas between about 0.5 m²/gram and about 5 m²/gram.

9. The secondary battery of claim 1, wherein said cathode material is free of trivalent metals.

10. The secondary battery of claim 1, wherein said cathode material is free of trivalent metals and the cathode material is represented by Li₁₊ₓMn_{2-x-z}M′_{z}O₄, where x is less than or equal to 0.25 and z is between about 0.1 and about 0.7.

11. The secondary battery of claim 1, wherein z is between about 0.2 and about 0.7

12. A cathode material comprising:
a lithium manganese oxide, wherein said lithium magnesium oxide is represented by Li₁₊ₓMn_{2-x-y-z}M_{y}M′_{z}O₄ where x is generally less than 0.25, y is less than about 0.5, z is between about 0.1 and about 0.7, M is a trivalent transition metal, M′ is a divalent transition metal.

13. The cathode material of claim of claim 12, wherein M′ is nickel.

14. The cathode material of claim 12, wherein M is up to 15% by weight of said cathode material.

15. The cathode material of claim 12, wherein M′ is between about 3% by weight and about 24% by weight of said cathode material.

16. The cathode material of claim 12, wherein said cathode material comprises less than 30 ppm Al, less than 130 ppm Ca, less than 90 ppm K, less than 75 ppm Mg and less than 35 ppm Fe.

17. The cathode material of claim 12, wherein said Mn₂O₃ particles within said lithium manganese oxide have surfaces areas between about 0.5 m²/gram and about 5 m²/gram.

18. The cathode material of claim 12, wherein said cathode material is free of trivalent metals.

19. The secondary battery of claim 12, wherein said cathode material is free of trivalent metals and the cathode material is represented by Li₁₊ₓMn_{2-x-z}M′_{z}O₄, where x is less than or equal to 0.25 and z is between about 0.1 and about 0.7.

20. The secondary battery of claim 19, wherein z is between about 0.2 and about 0.7
